(19) United States
(12) Patent Application Publication
(10) Pub. No.: US 2007/0295776 A1
(43) Pub. Date: Dec. 27, 2007

(54) Nurse/health care worker multifunctional tool/supply belt

(76) Inventor: Debra Tolley Whelan, Powder Springs, GA (US)

Correspondence Address: Debra T. Whelan, 635 Goldenwood Court, Powder Springs, GA, 30127, US

(21) Appl. No.: 11/803,429

(22) Filed: May 15, 2007

Related U.S. Application Data
(60) Provisional application No. 60/800,028, filed on May 15, 2006.

(51) Int. Cl. B25H 3/00

(52) U.S. Cl. 224/682

(57) ABSTRACT

The nurse health care worker multifunctional tool/supply belt (1) reduces work related back strain and fatigue by providing immediate access to frequently used supplies and personal tools. It is designed to reduce potential contamination of supplies. It consists of two pieces of medium weight washable fabric (1) stitched to a prefabricated nylon webbed belt (2) with the two sides of the belt (2) connected by a parachute style clip (7,8). Access to the pockets (3,4,5,11,10) is on the underside of the belt (2) to prevent items from falling from opened pockets (3,4,5,11,10) and to prevent pockets (3,4,5,11,10) from catching on nearby equipment and door handles. The insides of pockets 11 and 10 are secured by Velcro strips (9). Pockets 5 and 11 are heavily cross stitched (6) at the lower corners (6) to cause the pockets (5, 11) to remain vertical and lay flat against the wearer.

### CROSS-REFERENCE TO RELATED APPLICATIONS

Cross reference this application to provisional Patent Application No. 60/800,028 filed May 15, 2006. The international filing date is Jun. 2, 2006. This application makes formal application for the provisional patent granting the status of Patent Pending on the Nurse/health care worker multifunctional/tool supply belt granted on May 1, 2006.

### STATEMENT REGARDING FEDERALLY SPONSORED RESEARCH OR DEVELOPMENT

No federally funded or sponsored research was involved in the development of this invention. Therefore, the rights to patent this invention belong exclusively to the applicant.

### REFERENCE TO SEQUENCE LISTING, A TABLE, OR A COMPUTER PROGRAM LISTING COMPACT DISC APPENDIX

There are no sequence listings, tables, computer programs, or compact discs involved in this application.

### BACKGROUND OF THE INVENTION

The nurse health care worker multifunctional tool belt is designed to organize supplies and free the hands of workers. It does not restrict movement and can be worn between patient care areas without undue risk of spreading infection.

During my thirty year career as a registered nurse I have experienced heavy pockets on uniforms and lab coats weighted down with tools and supplies which catch on patient beds and doors and over time place strain on the wearer's neck and lower back. With an overall increase of nosocomial infections and pressure to work smarter not harder, nurses must keep some necessary personal items at hand and out of reach of patients. Essential tools such as scissors, hemostats, pen lights, markers, and alcohol swabs must be kept close by.

The nurse health care worker multifunctional tool belt provides safe access to supplies and tools. It is ergonomically designed to place heaviest items over each hip and its tailored front notches do not restrict movement at the waist or forward movement during walking. It does not fall on patient linens and is washable.

The belt skirt consists of a washable fabric belt stitched into pockets which enclose and support nurses tools attached to an adjustable webbed belt with a parachute clip. Velcro closures keep the rear pocket closed.

### BRIEF SUMMARY OF THE INVENTION

The nurse/health care worker multifunctional belt is designed to organize supplies, free the hands of the provider, reduce the spread of nosocomial infections, and reduce neck strain and fatigue, thereby reducing the incidence of job stress injuries. It places the location of the heaviest items the user must wear over the hips and lateral buttocks yet does not interfere with forward movement of the legs and thighs during walking, bending, or stooping. Its design is balanced to prevent compensatory strain due to prolonged weight bearing imbalance.

It provides safe access to tools and supplies. Unlike traditional fanny packs, it eliminates cross contamination of multiple items. It does not interfere with movement of the waist during patient care activities. Most importantly, it does not fall on the patient of the patient's linens during patient care activities such as turning, dressing changes and bathing. It provides safe access to the multitude of disposable supplies and indispensable expensive personal tools such as stethoscopes and hospital phones needed for every day duties.

Applications of this design have multiple applications for child care workers, teachers, students, parents, or anyone who must have access to multiple small tools quickly while keeping one's hands otherwise or duty.

### BRIEF DESCRIPTION OF THE SEVERAL VIEWS OF THE DRAWING

FIG. 1 shows the outside view of the invention as seen from the rear with the parachute clip open.

FIG. 2 shows the inside view of the invention worn against the user with the parachute clip closed.

FIG. 3 shows how the Velcro is applied to the inside of the pockets.

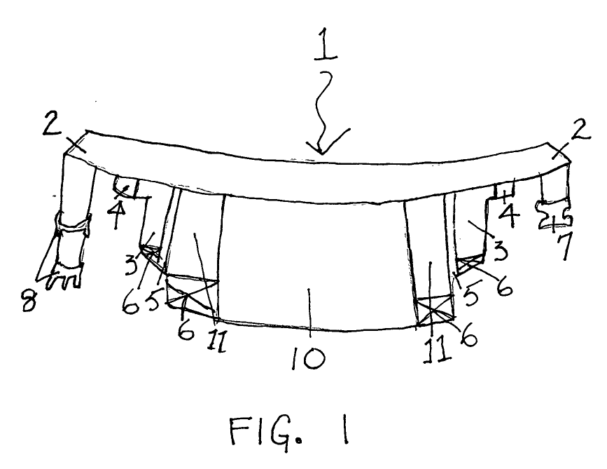

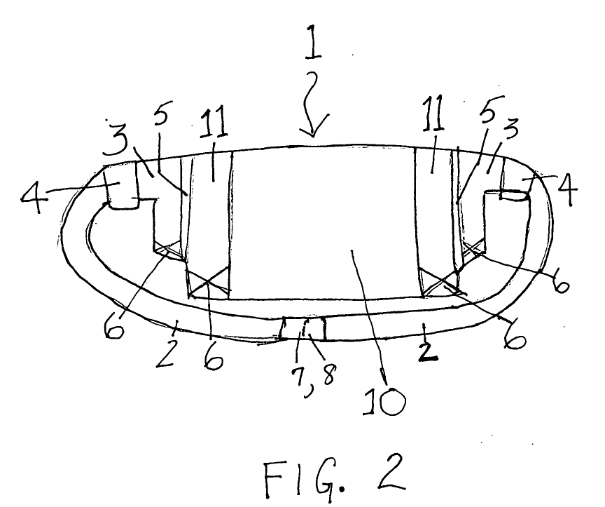

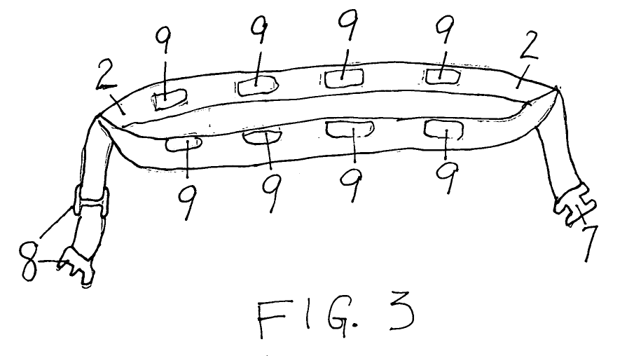

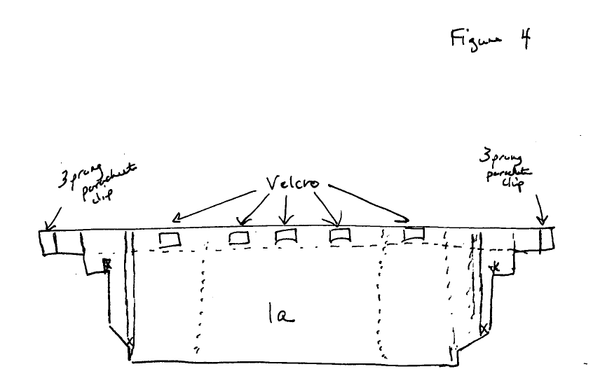

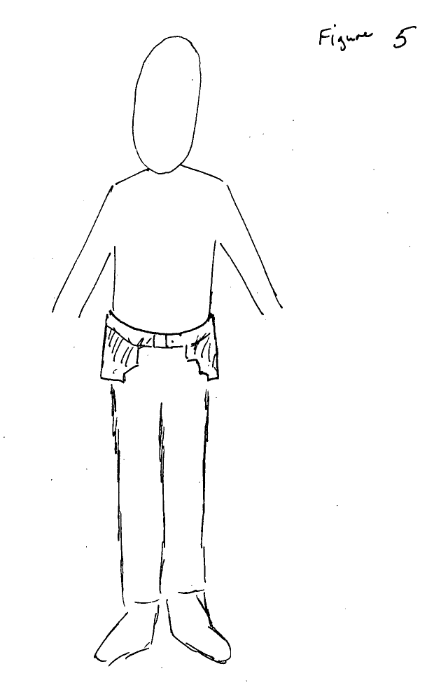

### DETAILED DESCRIPTION OF THE INVENTION

The multipurpose nurse/health care worker tool belt (1) consists of two pieces of medium weight fabric such as cotton duck or denim stitched to nylon webbing (2) connected at the front by a parachute clip (7,8). The fabric pieces (1) are stitched together on three sides forming a pouch. The pouch (1) is subdivided with vertical stitching into pockets (3,4,5,10, 11) sized to hold disposable items and personal tools. Dense cross stitching (6) at the corners of pockets (3,5 11) allows the pockets (3,4,5) to lay flat against the wearer. The pockets (3,4,5,11) are arranged symmetrically with the adjustable buckle (7,8), the parachute clip, at center. At the back of the belt (1) is a large deep pocket (10) for miscellaneous items. The pockets use Velcro closures (9).

One end of fabric (1) is sewn to a pre-fabricated nylon belt webbing (2). The webbing (2) extends beyond each end sufficiently to attach to each end of the parachute clip (7,8). The two pieces of fabric (1) are cut in rectangles with right angles cut into front of each side making a small pocket (4) on each side of the buckle (7,8). Vertical stitching divides the pouch into smaller pockets (3,4,5,10,11). Pockets (3) are stitched to accommodate handles of scissors and hemostats.

Velcro strips (9) are sewn inside pockets (10, 11) keeping the larger pockets closed when not in use.

The belt (1) is similar to other tool/service belts in that it uses conventional zigzag stitching and serged seams. Other types of carrying devices such as fanny packs also employ parachute clips for adjustable closure.

The belt (1) differs specifically from other tool belts and carrying belts in the cutaway details of the front pockets (4,3,5) and the positioning of additional pockets (11, 10) to provide balanced weight distribution. Pocket arrangement (3,4,5) permits the wearer to bend and stoop without compromising the wearer's balance or risking contamination of supplies.

1. The multipurpose nurse/heath care worker tool belt (1) employs a unique arrangement of pockets (3,4,5,10, 11) each designed to accommodate and store frequently needed items. Stitched weighted corners (6) keep the pockets (3,5, 11 ) vertical, flat against the wearer, and readily accessible. Arrangement of the pockets (4) to allow free movement of waist and legs, easy access to most frequently used supplies (3,4,5) even distribution of heavier items (11) over large muscle groups to reduce fatigue. The largest pocket (10) rests over the buttocks reducing lumbar strain. Velcro closures (9) on the inside of the webbed belt (2) secure tools in the belt pockets (1). The webbed belt (2) uses a three pronged (8, 7) parachute clip for closure.
